(19) United States
(12) Patent Application Publication
(10) Pub. No.: US 2008/0002065 A1
(43) Pub. Date: Jan. 3, 2008

(54) Image processing circuit, image processing system and method therefor

(75) Inventor: Ryuuji Waseda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/822,056

(22) Filed: Jul. 2, 2007

(30) Foreign Application Priority Data
Jun. 30, 2006 (JP) 2006-182808

(51) Int. Cl. H04N 9/64

(52) U.S. Cl. 348/714; 348/716

(57) ABSTRACT

Each functional block constituting a pipeline resets its own memory device in synchronization with a timing that last pixel data of one line is processed and output. A reset controlling unit in a first functional block includes an attribute signal generation circuit for generating an attribute signal indicating whether or not each pixel data being input is last pixel data and attaches this attribute signal to the pixel data by transferring in synchronization with corresponding pixel data. When the processed pixel data is output, the attribute signal of the corresponding pixel data is referred to control resetting the memory device. Other functional blocks control resetting their own memory devices using an attribute signal synchronized with the pixel data and transferred from previous functional block.

### BACKGROUND OF THE INVENTION

1. Field of the Invention

The present invention relates an image processing technique, and particularly to a technique for processing pixel data by each line.

2. Description of the Related Art

Various image processes are performed on image data to play. In these image processes, one screen is divided into lines for example, and pixel data for each line is processed sequentially.

FIG. 14 shows a horizontal filter 10 for performing a horizontal filtering process to pixel data of one line, as an example of device carrying out such process. The horizontal filter 10 is a 5-tap filter that includes 6 flip-flops (hereinafter referred to as F/F) 2a to 2e and F/F7, 5 multipliers 4a to 4e, adder 5 and divider 6. Pixel data is input to the horizontal filter 10 from leftmost in one line and stored to the F/F2e, F/F2d, F/F2c, F/F2b and F/F2a in order of input. Each of the multipliers multiplies the pixel data stored to corresponding flip-flip by a filter parameter (multiplier coefficient in this example). The multiplier 5 inputs to the divider 6 the sum of 5 pixel data multiplied by the filter parameters using the multipliers. The divider 6 divides the sum by 5 and outputs this result to the F/F7 as a processing result for the pixel data that is stored to the F/F2c located at the center of the 5 flip-flops 2a to 2e. This process is referred to as a horizontal filtering process hereinafter. The F/F7 temporarily stores this result for later processes. Incidentally, 5 multipliers 4a to 4e, adder 5 and divider 6 are collectively referred to as a processing unit 8 hereinafter.

Here, a process is described in which pixel data A, B, C, D and E is input to the horizontal filter 10 in order. Firstly the pixel data A is input to the horizontal filter 10 and stored to the F/F2a. At a horizontal filtering process, the multiplier coefficient to be multiplied differs according to the pixel data stored to each flip-flop. For example a larger multiplier coefficient may be multiplied to the largest pixel data stored to the F/F2c. This means that the pixel data stored to the F/F2c is weighted the most and is to be processed by the processing unit 8. Thus, a process is performed to the pixel data stored to the F/F2c, and after the result of the process is stored to the F/F7, the result is output from the horizontal filter 10. Then each pixel data stored to the F/Fs 2a to 2e is moved to the previous flip-flop (immediate right flip-flop in the example of FIG. 14) to overwrite the original pixel data. At the same time, the pixel data B is input to the F/F2a. At this time, the pixel data A is stored to the F/F2b.

As the processes go on and when the pixel data A is stored to the F/F2c, the pixel data B and C is stored respectively to F/F2b and F/F2a. Here, the process result of the horizontal filter 10 is a result for the pixel data A.

These processes are repeated and pixel data at the end of one line is stored to the F/F2c. Then this pixel data is processed and moved to the immediate right flip-flop. To be more specific, after processing the pixel data at the end of one line, in the F/F2d and F/F2e of the horizontal filter 10, pixel data at the end of this line and previous pixel data is stored.

As described above, as the leftmost pixel data of the line is input first to the horizontal filter 10 among the pixel data of the line, this pixel data is hereinafter referred to as first pixel data. A case is described in which the first pixel data is stored to the F/F2c in the horizontal filter 10 and the horizontal filter 10 obtains the process result of this pixel data.

At this time, the pixel data following the first pixel data and further subsequent pixel data is stored in the F/F2b and F/F2a. On the other hand, pixel data of the previous line is stored to the F/F2d and F/F2e. In this case, when performing the abovementioned filtering process regardless of whether the pixel data stored to the F/F2c is first or not, pixel data of other line processed before remains in the F/F2d and F/F2e, and there is a problem that the process result for the first pixel data of the line is influenced by the pixel data of the line processed before.

This is same when processing last pixel data of one line. If this data is held to the F/F2c, pixel data of a line to be processed next is held to the F/F2a and F/F2b. In such case also, when processing regardless of whether the pixel data stored to the F/F2c is last pixel data or not, there is a problem that the process result for the last pixel data is influenced by the pixel data of the line processed next.

On the other hand, in recent years, a pipeline is often used as a method for parallelizing hardware to improve performance. Specifically, a process is divided into two or more stages to process each stage in parallel. Such stages are referred to as functional blocks hereinafter.

The pipeline is used to perform several processes to image data. FIG. 15 is a schematic view of a pipeline for performing image processes including horizontal filtering process to image data using a horizontal filter as one functional block. Note that FIG. 15 also indicates a method for overcoming the abovementioned problem in such pipeline.

The pipeline shown in FIG. 15 is constituted of several (8 in this example) functional blocks 20a to 20h. The functional block 20a, one of the functional blocks, is the horizontal filter 10 shown in FIG. 14. Pixel data is input sequentially by line and processed by each functional block in series. Further, a line reset signal is generated synchronizing with a timing to output after processing the last pixel data of one line by the last functional block (functional block 20a), and then memory devices in each functional block (this process is hereinafter referred to as a line reset) are reset. Furthermore, first pixel data of the next line is input synchronizing with this. By doing this, in the functional block 20a (the horizontal filter 10 shown in FIG. 14) for performing a horizontal filtering process, when performing a process to the first pixel data, two memory devices F/Fs 2d and 2e following the F/F2c that stores this pixel data are reset.

An image processing device incorporating such method is disclosed in Japanese Unexamined Patent Application Publication No. 2005-78608.

Here, state of each functional block is considered when processing the first and last pixel data of one line in an image data by the pipeline of FIG. 15.

FIGS. 16A and 16B show the state of each functional block along with the progress of processes when processing first pixel data of one line by the pipeline shown in FIG. 15.

As described above, image data is input to a pipeline by each pixel. A line reset signal is generated in synchronization with completing to process last pixel data of one line and the result being output from the pipeline. Memory devices of each functional block are reset in response to the line reset signal. Then to process the next line, as shown in FIG. 16A, firstly the first pixel data of next line is input to the functional block 20a. At this time, the functional block 20a operates and other functional blocks are in waiting state.

As the input of pixel data and process by the functional block 20a progress, as shown in FIG. 16B, the functional block 20a outputs the result from performing a process to the first pixel data to the next functional block 20a, and this result is stored to a memory device of the functional block 20b. At this time, next pixel data is input to the functional block 20a, the functional blocks 20a and 20b operates and other functional blocks are in waiting state.

As described above, when performing a process to first pixel data, functional blocks to the lower side must wait until receiving process result from functional blocks to the upper side. Thus after one line reset, for the lowest functional block (functional block 20h) of the pipeline to start operating, it will be several dozens of clocks after the top functional block (functional block 20a) starts operating. Needless to say that the more number of functional blocks included in the pipeline, the longer the waiting time for the functional block to the lower side after one line reset.

On the other hand, when processing the last pixel data, the functional block that has processed it must wait after outputting the process result to the lower functional block than itself until the functional block 20h completes processing last pixel data and the memory device is reset by a line reset signal.

FIG. 17A shows the state of a pipeline when completing the process of the functional blocks 20a to 20f for the last pixel data. At this time, the functional blocks 20g and 20h are operating while the functional blocks 20a to 20f are in waiting state.

Further as shown in FIG. 17B, after the functional block 20g completes processing last pixel data and output the process result to the functional block 20h, only the functional block 20h operates and the functional blocks 20a to 20g are in waiting state.

Further, as shown in FIG. 17C, after completing to process the last pixel data by the functional block 20h and the process result is output, a line reset signal is generated and memory devices of each functional block are reset.

Specifically, in a pipeline constituted of a plurality of functional blocks, with a method to synchronize with a timing to complete processing last pixel data by the lowest functional block to output the process result so as to reset memory devices of each functional block at a time that are included in the pipeline, when processing the first pixel data, the functional block to the lower side must wait while when processing the last pixel data, the functional block to the upper side must wait.

### SUMMARY

It is expected that higher performance including higher resolution and higher quality picture is further pursued and thus the image processing devices to carry out more processes. Thus the number of stages in a pipeline also increases. In the abovementioned line reset method, as the waiting time further increase for the number of stages to be added, a dilemma is created with higher performance but increased processing time.

According to a first aspect of the present invention, there is provided an image processing circuit. The image processing circuit sequentially processes each pixel data constituting one line and includes a plurality of memory devices each holding the pixel data being sequentially input, a processing unit to process pixel data held by a predetermined memory device among the plurality of memory devices and a reset controlling unit to reset the plurality of memory devices in synchronization with a timing of last pixel data of the one line being processed and output by the processing unit.

According to a second aspect of the present invention, there is provided an image processing system. The image processing system includes a plurality of the image processing circuits of the first aspect being connected in order for a lower image processing circuit to sequentially processes pixel data output from an adjacent upper image processing circuit.

According to a third aspect of the present invention, there is provided an image processing circuit. The image processing circuit sequentially processes each pixel data constituting one line and includes a controlling unit to generate and attaches an attribute signal to each of the pixel data being input, the attribute signal indicating whether or not the pixel data is first pixel data or last pixel data.

According to a fourth aspect of the present invention, there is provided an image processing system. The image processing system includes a plurality of image processing circuits being connected to sequentially process each pixel data constituting one line in order for a lower image processing circuit to sequentially process pixel data output from an adjacent upper image processing circuit. A top image processing circuit is the image processing circuit of the third aspect.

In the explanation of the present invention, “attaching an attribute signal to pixel data” means that when processing the pixel data, corresponding attribute signal can be obtained and when this pixel data processed and output, the same attribute signal can be obtained for output data. For example, an attribute signal may be attached to pixel data to transfer through same transfer path or different path synchronously.

Incidentally, a combination of above aspects, or the image processing circuit and image processing system replaced with a method are effective as an aspect of the present invention.

With the image processing circuit and image processing system of this embodiment, processing speed can be improved in processing pixel data by each line.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows the configuration of a receiving system according to a first embodiment of the present invention;

FIG. 2 shows the configuration of a display processing unit in the receiving system of FIG. 1;

FIG. 3 explains the configuration of a frame;

FIG. 4 shows the configuration of a frame processing unit in the display processing unit of FIG. 2;

FIG. 5A shows the configuration of a first functional block in the frame processing unit of FIG. 4;

FIG. 5B shows another configuration example of a first functional block in the frame processing unit of FIG. 4;

FIG. 6 shows the configuration of another functional block in the frame processing unit of FIG. 4;

FIGS. 7A to 7D show the state of each functional block along with progress of processes by the frame processing unit of FIG. 4;

FIGS. 8A and 8B explain line switch waiting time;

FIG. 9 shows a frame processing unit in a receiving system according to a second embodiment of the present invention;

FIG. 10 shows the configuration of a first functional block in the frame processing unit of FIG. 9;

FIG. 11 shows the configuration of a first functional block in the frame processing unit of FIG. 9;

FIG. 12 shows the configuration of a frame processing unit in a receiving system according to a third embodiment of the present invention;

FIG. 13 shows the configuration of a functional block in the frame processing unit of FIG. 12;

FIG. 14 shows the configuration of a horizontal filter;

FIG. 15 explains a method according to a conventional technique;

FIGS. 16A and 16B explain a problem of a conventional technique; and

FIGS. 17A to 17C explain another problem of a conventional technique.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

FIG. 1 shows a receiving system 100 of a television picture according to a first embodiment of the present invention. The receiving system 100 includes a receiving unit 105 for receiving television pictures, display processing unit 180 for performing processes to display received image data and display unit 190 such as a display for playing image data processed by the display processing unit 180.

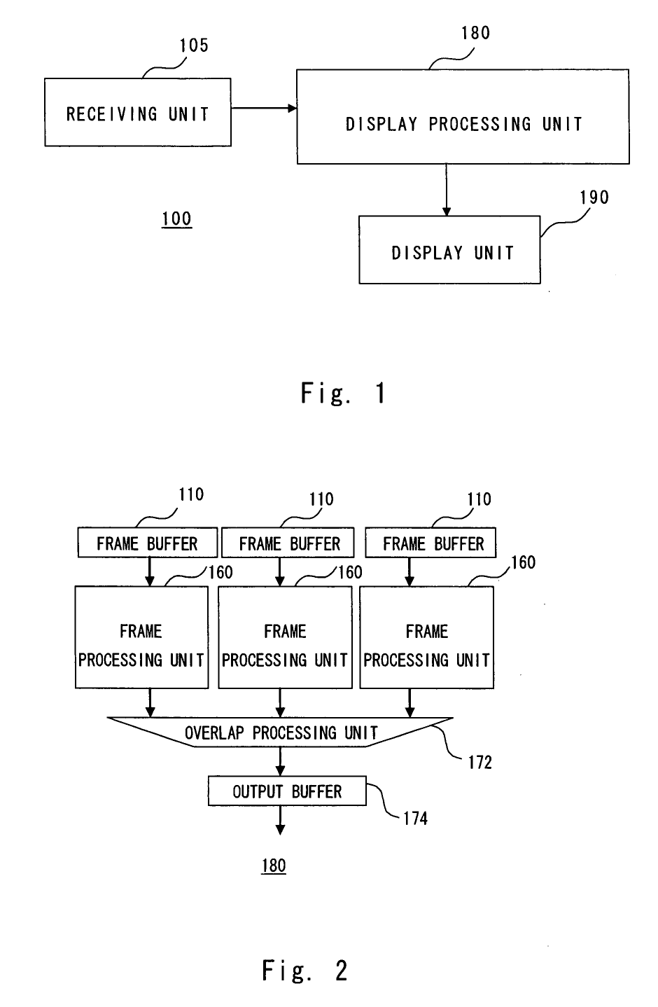

FIG. 2 shows the configuration of the display processing unit 180 in the receiving system 100 of FIG. 1. The display unit 180 includes 3 frame buffers 110 for temporarily storing frame data from the receiving unit 105, 3 frame processing units 160 each corresponding to the 3 frame buffers and reading out frame data from the corresponding frame buffer so as to perform image processes for each frame, overlap processing unit 172 for overlapping the three frames each processed by the 3 frame buffers in order to obtain a display frame and output buffer 174 for temporarily storing the display frame until it is output to the display unit 190. As the display processing unit 180 includes 3 frame processing units 160 that are able to process one image (which is one frame), frames of 3 in total can be overlapped to display. In the display processing unit 180 of this embodiment, the 3 frame processing units 160 have same functions and operate in parallel. This enables to perform same processes to the 3 frames at the same time. Note that an example is illustrated in which 3 frames are overlapped to display, however the number of frames to overlap and display, which is consequently the number of frame processing unit, is not limited to 3. Note that the frame processing unit 160 functions as an image processing system in the claims.

Each frame is constituted of pixel data. Data is output the frame buffers to the frame processing units by synchronizing to dot clock (DotCLK) not shown and outputting by each pixel in order of raster scan from upper left of the image that is displayed by the frames. A dot clock is a clock signal defined by the standard for processing pixel data. For dot clock in the standard to display images by a television receiver, there are for example 13.5 MHz, 27 MHz, 54 MHz and 74.25 MHz and recently on the scene is 85 MHz (WXGA) and 148.5 MHz (full HD).

Further, clocks called data path clock (DPCLK) are used in the process from the frame processing units 160 to the overlap processing units 172. In the image processes performed by the frame processing units 160, a process for reducing 2 pixels to 1 pixel may be included. In such case, it is not possible to synchronize with dot clocks to output processed frames unless processing with clocks with higher speed than dot clocks. Thus the data path clocks are higher speed than the dot clocks.

Before explaining the frame processing units 160, frames to be processed by the frame processing units 160 are explained hereinafter.

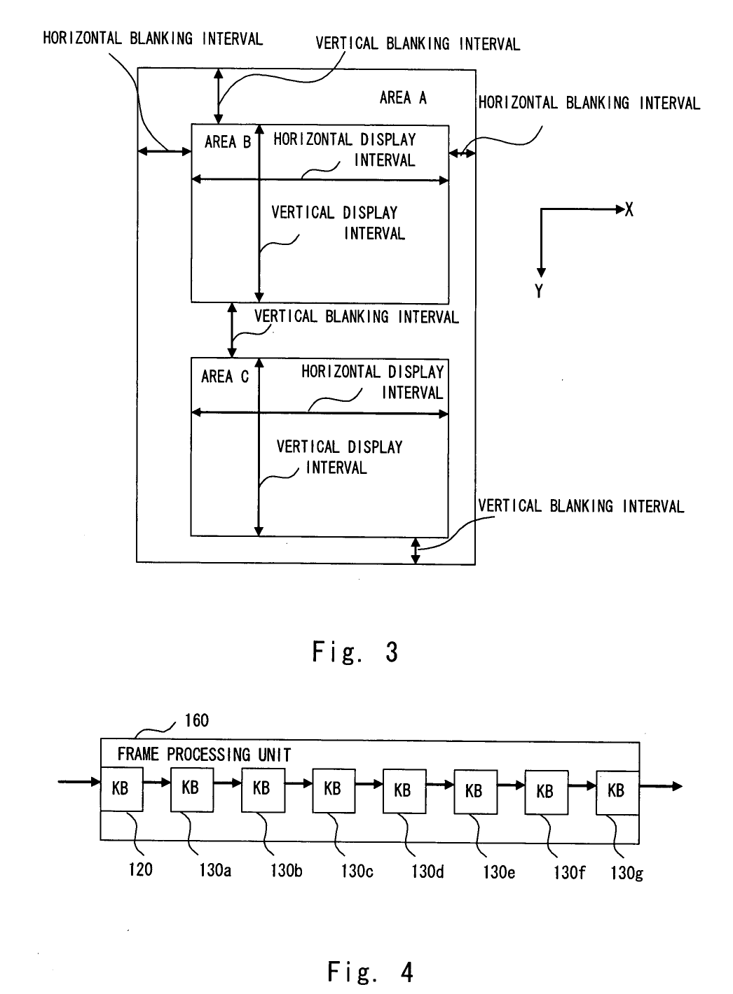

In the standard for displaying images, there are blanking and display area for frames. FIG. 3 shows area configuration of a frame. Areas B and C in FIG. 3 are display areas and an area A other than the display areas is a blanking area. Note that the units of X and Y axes in FIG. 3 are the number of pixels.

The frame processing unit 160 includes a scanning unit that scans by each pixel in order at a rate of dot clock from top left (top left of the area A in the example of FIG. 3) towards the direction of X axis of FIG. 3, which is right. When reaching to the rightmost of the frame, scanning starts from leftmost and one pixel below toward right. If the frame processing unit 160 is scanning the display area, pixel data is input to the frame processing unit 160. On the other hand if the frame processing unit 160 is scanning the blanking area, there is no pixel data input to the frame processing unit 160. Hereinafter, X and Y directions are each referred to as a sub scanning direction and main scanning direction. Further, a scan from leftmost to rightmost with same height in the main scanning direction is referred to as one sub scan.

The interval along with the sub scanning direction of the display area is referred to as a horizontal display interval and the interval along with the main scanning direction of the display area is referred to as a vertical display interval. Further, outside the display area, the interval in the sub scanning direction of the blanking area adjacent to the display area in the sub scanning direction is referred to as a horizontal blanking interval and the interval in the main scanning direction of the blanking area adjacent to the display area in the main scanning direction is referred to as a vertical blanking interval. While the frame processing unit 160 is scanning the horizontal and vertical blanking interval, there is no pixel data read into the frame processing unit 160. Incidentally, the period when the scanning unit is scanning the horizontal blanking interval is hereinafter referred to as a “horizontal blanking period”.

Hereinafter, a case is described in which the frame processing unit 160 processes pixel data read out from the frame buffer 110. In the explanation below, the pixel data is obtained by scanning the display area, and pixel data obtained by one sub scan is pixel data of the same line. Further, when reading out first pixel data, the scanning unit of the frame processing unit 160 also obtains the horizontal size of the line, which is the number of pixels in the horizontal display interval to input to the frame processing unit 160.

FIG. 4 shows the configuration of the frame processing unit 160. The frame processing unit 160 includes the abovementioned scanning unit (not shown) and a plurality of (8 in this example) functional blocks. These functional blocks each carry out filtering or upsampling process etc. To distinguish the first functional block from other functional blocks, the first functional block is given the code 120 and other functional blocks are given the codes 130a to 130g. Incidentally, the functional blocks correspond to image processing circuits in the claims.

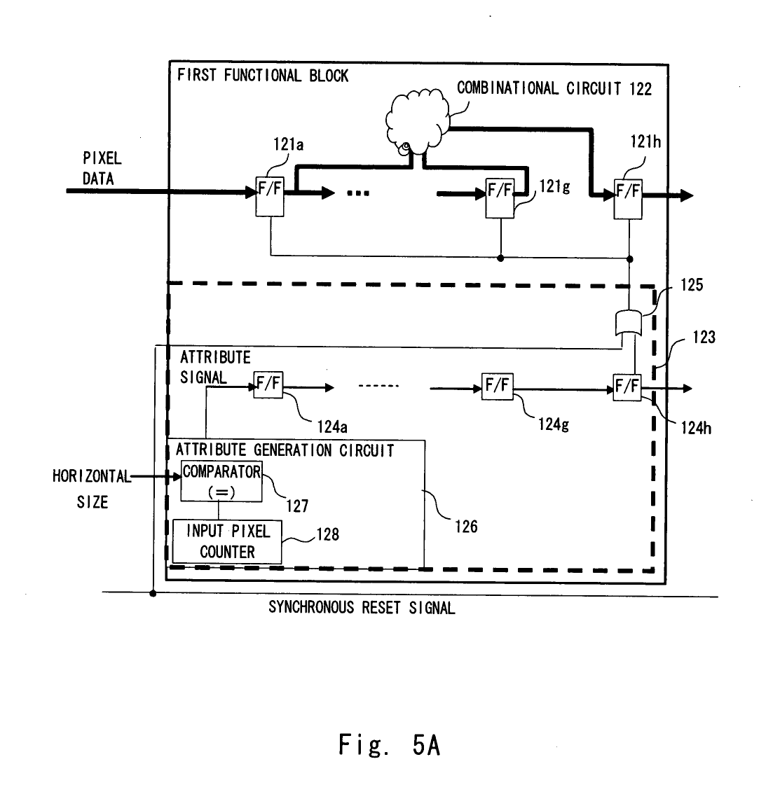

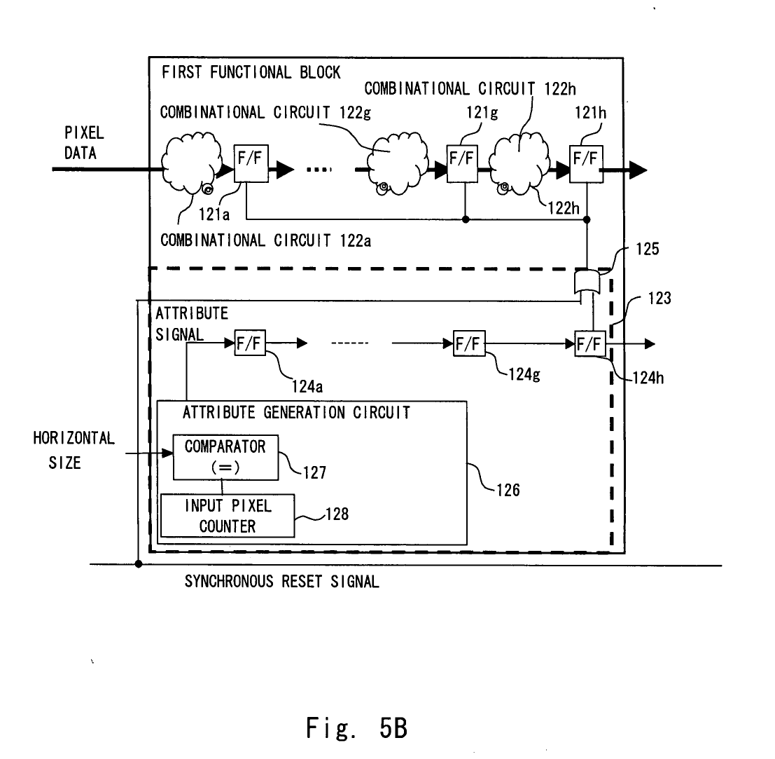

FIG. 5A shows the configuration of the first functional block 120. The first functional block 120 includes a plurality of flip-flops, which is 8 in this example, F/Fs 121a to 121h and a combinational circuit 122 for processing pixel data stored to the F/Fs 121a to 121g. The last flip-flop F/F121h sequentially passes the pixel data processed by the combinational circuit 122 to the next functional block. Pixel data of one line is input to the first functional block 120 by each pixel, sequentially stored to the F/Fs 121a to 121g and processed in series. As with the example of the horizontal filter 10, for the process of the pixel data to be processed, pixel data before and after this pixel data may be used. Note that each flip-flop has capacity corresponding to the bit width of pixel data. For example for 8 bits pixel data, a flip-flop has a capacity of 8 bits.

The first functional block 120 further includes a reset controlling unit 123. The reset controlling unit 123 includes an attribute signal generation circuit 126 and 8 flip-flops (F/Fs 124a to 124h for attribute signal) used to transfer an attribute signal and a reset signal outputter 125.

The attribute signal generation circuit 126 generates a signal indicating whether pixel data is the last pixel data of one line (the signal hereinafter referred to as an attribute signal) and activates the attribute signal at the same time when the last pixel data of one line is input to the first functional block 120. The attribute signal generation circuit 126 includes a comparator 127 and an input pixel counter 128. The input pixel counter 128 counts the number of pixels input to the frame processing unit 160 from when first pixel data of one line is input. The comparator 127 compares a horizontal size input along with the first pixel data by the scanning unit with the number of pixels counted by the input pixel counter 128 and activates an attribute signal only when the counted number of pixels reaches the horizontal size.

The attribute signal is synchronized with pixel data corresponding to the attribute signal by the flip-flop for each attribute signal and transferred. When the process result of the pixel data is stored to the last stage F/F121h, corresponding attribute signal is also stored to the F/F121h for attribute signal. Further, when the process result for pixel data is output to the next functional block, the attribute signal stored to the F/F124h for attribute signal is also output to the next functional block.

The reset signal outputter 125 outputs a reset signal when the process result for the pixel data is output from the F/F121h in the first functional block 120 to the next functional block and if the attribute signal from the F/F124h for attribute signal is active. This resets the F/Fs 121a to 121h in the first functional block 120. Specifically, in synchronization with a timing when the last pixel data of one line is output from the F/F121h, the F/Fs 121a to 121h in the first functional block 120 are reset.

Note that the reset signal outputter 125 outputs a reset signal when receiving a synchronous reset signal so as to reset the F/Fs 121a to 121h in the first functional block 120 besides when the last pixel data processed and output. A synchronous reset signal is a reset signal for arbitrarily initializing the whole display processing unit 180 from outside. The synchronous reset signal is input from a circuit (not shown) provided for that purpose when attempting to reset the display processing unit 180.

FIG. 5A is an example of a functional block having the combinational circuit 122 for processing pixel data that is stored to a plurality of flip-flops. However as shown in FIG. 5B, the first block provided with a combinational circuit (122a to 122h in FIG. 5B) for each flip-flop to process pixel data stored to the flip-flops by each combinational circuit may be used.

Incidentally, in the explanation and drawings hereinafter, all the functional blocks having a combinational circuit for processing pixel data stored to a plurality of flip-flops may be functional blocks provided with a combinational circuit for each flip-flop.

Next, the functional blocks 130a to 130g other than the first functional block 120 are described hereinafter.

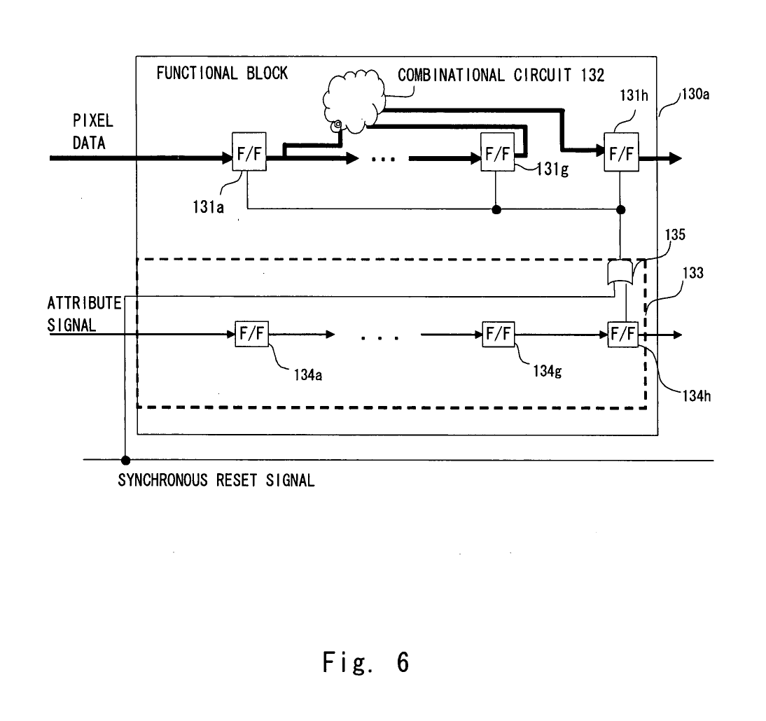

FIG. 6 shows the configuration of the functional block 130a. The functional block 130a includes a plurality of flip-flops (8 in this example) F/Fs 131a to 131h and a combinational circuit 132. The last flip-flop F/F131h sequentially passes the pixel data processed by the combinational circuit 132 to the next functional block. Pixel data (result processed by the previous functional block) of one line is input to the functional block 130a by each pixel, sequentially stored to the F/Fs 131a to 131g and processed in series.

The functional block 130a further includes a reset controlling unit 133. The reset controlling unit 133 includes 8 flip-flops (F/Fs 134a to 134h for attribute signal) used to transfer an attribute signal that is synchronized with pixel data and output and a reset signal outputter 135. Each of the F/Fs 134a to 134h for attribute signal and reset signal outputter 135 are same as the corresponding components in the first functional block. Thus detailed explanation will be omitted here.

Specifically, the reset controlling unit 123 in the first functional block 120 includes an attribute signal generation circuit 126 so as to control resetting the F/Fs 121a to 121h in the first functional block 120 using an attribute signal generated by the attribute signal generation circuit 126. On the other hand, in response to an attribute signal output with pixel data from the first functional block, the reset control unit 133 in the first functional block 130a controls the F/Fs 131a to 131h in the functional block 130a using the attribute signal.

Although the functional block 130a is described here, as the functional blocks 130b to 130g have same configuration as the functional block 130a, detailed explanation for the functional blocks 130b to 130g will be omitted here.

As described above, an attribute signal is generated by the attribute signal generation circuit 126 provided to the first functional block 120, synchronized with corresponding pixel data and transferred from the previous functional block to the next functional block. Each of the functional block controls to reset itself using this attribute signal. Specifically, when outputting pixel data corresponding to an active attribute signal (which is specifically the last pixel data), memory of the memory device in the functional block is reset.

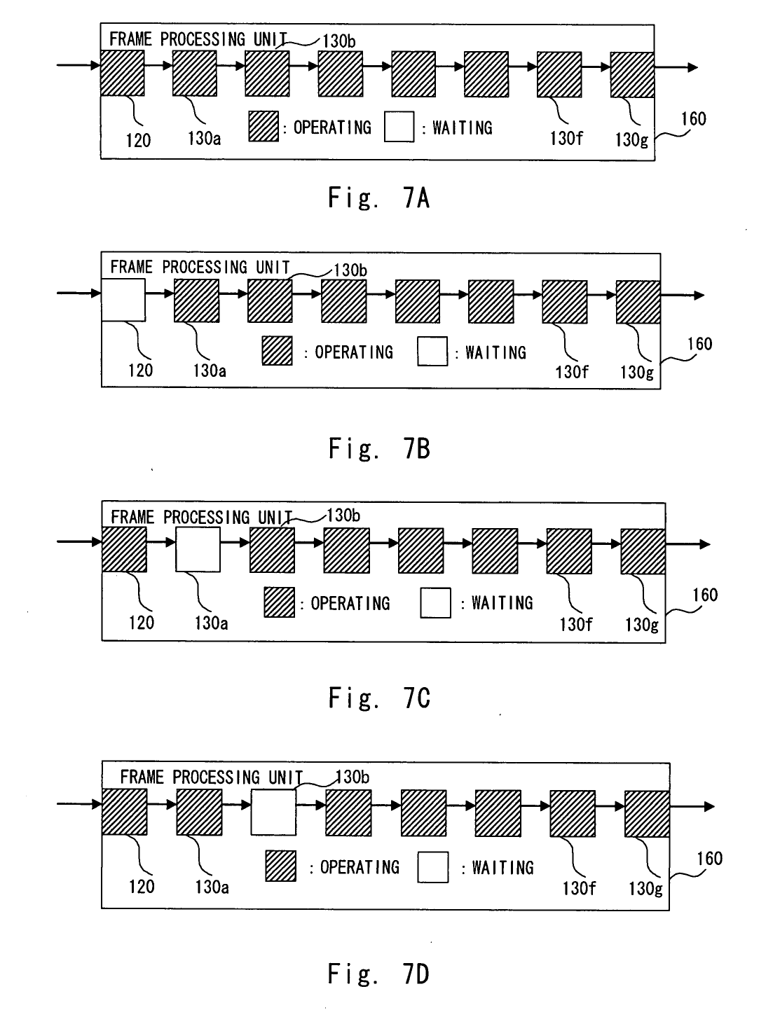

FIGS. 7A to 7D show the state of each functional block along with the progress of processes by the frame processing unit 160.

FIG. 7A shows the state when each functional block in the frame processing unit 160 is in operation. In this state, the functional block to the upper side and lower side may be processing pixel data in different lines.

As shown in FIG. 7B, in the state of FIG. 7A, by the first functional block 120 processing the last pixel data of one line in process to output, each memory device of its own is reset.

Further, as shown in FIG. 7C, the first functional block 120 starts processing the first pixel data in the next line and becomes to be in the operating state. Furthermore, when the next functional block 130a completes processing the last pixel data of a line in process and outputs the process result, each memory device of its own is reset.

Along with the progress of processes, as shown in FIG. 7D, the functional block 130a processes the first pixel data in the next line that is output from the first functional block 120. Moreover, when the functional block 130b, the next block of the functional block 130a, completes processing the last pixel data of the line in process and outputs the process result, each memory device of its own is reset.

As described above, if the pixel data processed by each functional block in the frame processing unit 160 is the last pixel data, the functional block synchronizes with a timing to output the process result so as to reset its own memory device. By doing this, it is possible to reduce waiting time for the functional block to the lower side when processing the first pixel data and waiting time for the functional block to the upper side when processing the last pixel data, thereby improving processing speed.

In a system for receiving television video signal to display, reducing the waiting time of the functional blocks in the frame processing unit 160 especially brings great significance.

For example, products supporting digital high-definition broadcast and the standard (1080P) for further higher resolution are being developed. In such products, in order to support high performance display, dot clocks in the display unit 190 of FIG. 1 are high-speed and an operating frequency (which is data path clock) of a circuit for processing image data (corresponding to the display processing unit 180 or frame processing unit 160 in FIG. 2) needs to follow the speed. However, as improving the operating frequency of the image processing apparatus causes problems of increasing circuit size and complicating control it can be expected that that this makes it difficult to build a system. TO avoid such problem, a method can be considered in which a frequency of data path clock is reduced to change the frequency ratio of data clock and dot clock from 2:1 to be closer to 1:1, for example.

Here, for the pipeline constituted of a plurality of functional blocks, time from after the top functional block processes and outputs the last pixel data of one line until the first cell data of next line is input is considered. This time is referred to as line switch waiting time hereinafter.

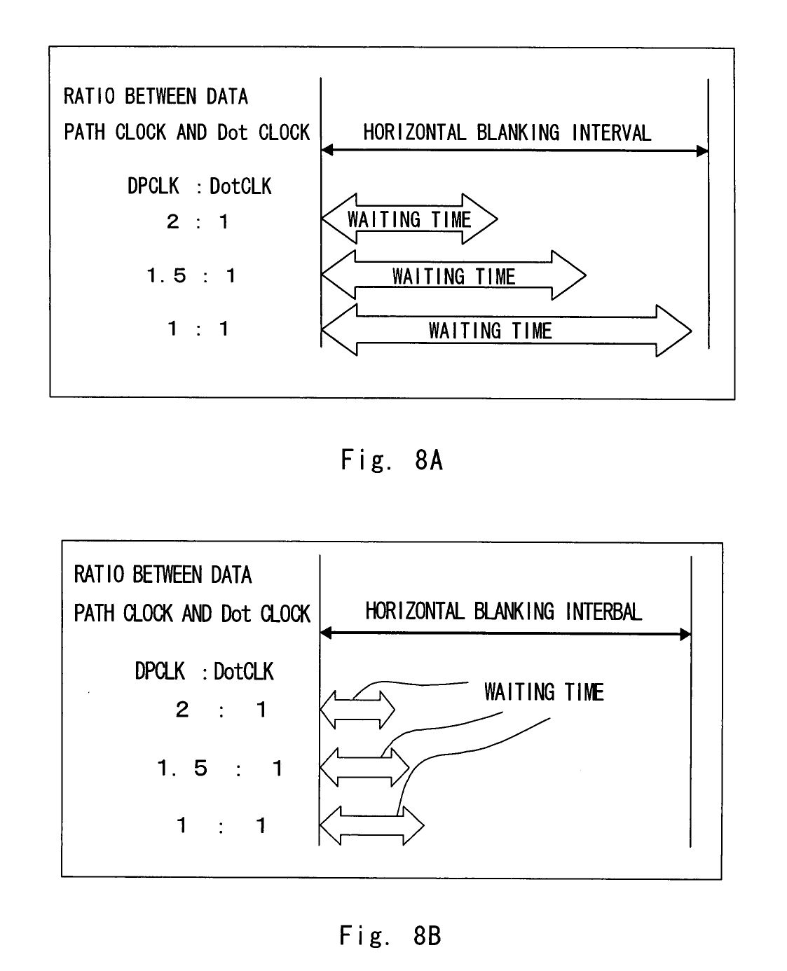

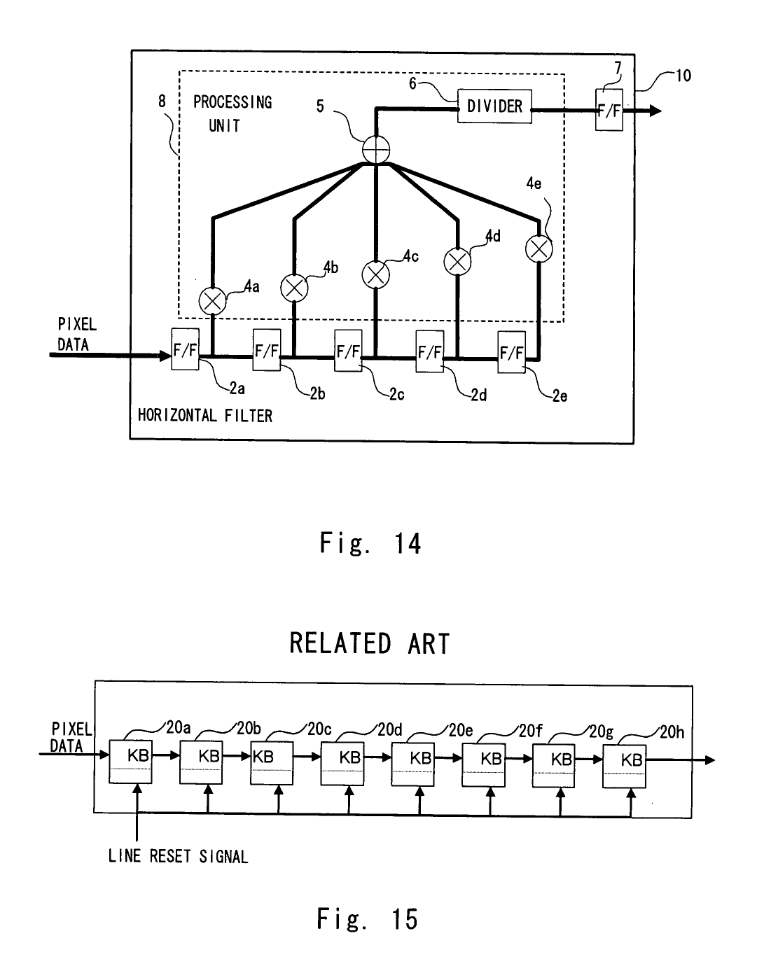

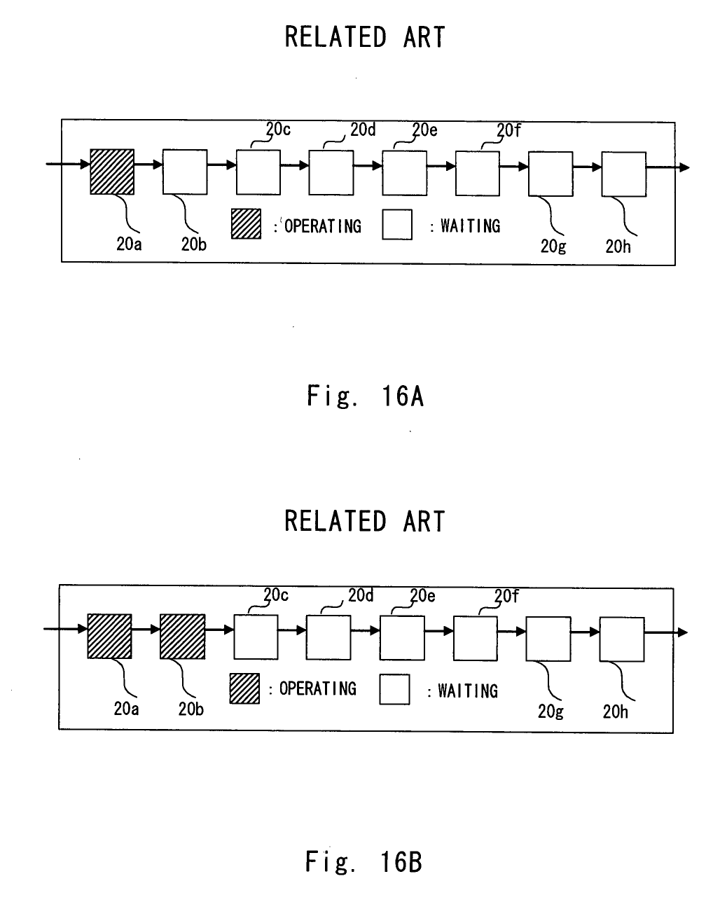

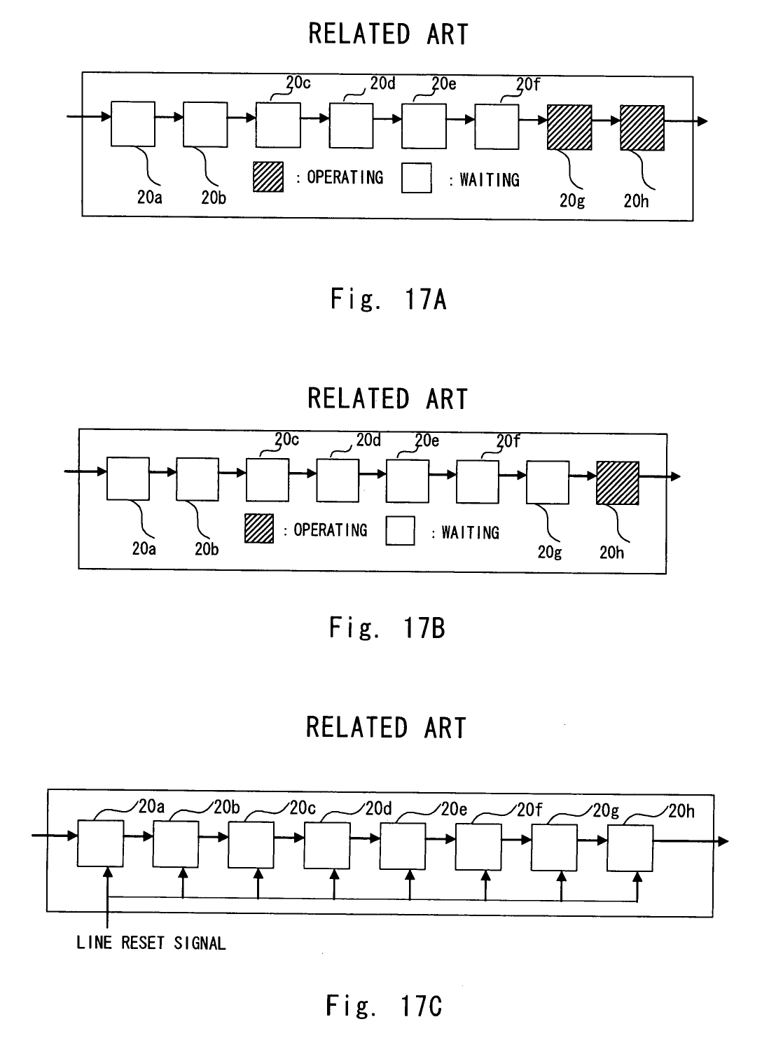

FIG. 8A shows the line switch waiting time with frequency ratio of data path clock and dot clock as 2:1, 1.5:1 and 1:1 when using a method to reset lines for each of the functional blocks as shown in FIG. 15 at a time. When requiring 20 cycles to perform a line switch for example, same clock cycle is needed for data path clock of any frequency. Thus as shown in FIG. 8A, the closer the data path clock to the dot clock, the more line switch waiting time it takes.

Further, as described above, it is expected that the number of stages in the pipeline increases to achieve high performance play and this further increases the line switch waiting time.

Long line switch waiting time compresses the horizontal blanking period. As a result, a buffer that stores image data may not be able to output data within the horizontal display period and image to display cannot be input. This could cause a phenomenon to distort image.

FIG. 8B shows line switch waiting time with frequency ratio of data path clock and dot clock as 2:1, 1.5:1 and 1:1 in case of using a method to reset memory devices when each functional block completes processing last pixel data, as with each frame processing unit 160 in the display processing unit 180 of FIG. 2. As this method resets for each functional block, it enables to start processing the next line without waiting for the lowest functional block to process the last pixel data. Thus the switch waiting time can largely be reduced as shown in FIG. 8B. Accordingly, it is possible to prevent from image distortion that is caused by the switch waiting time compressing the horizontal blanking time. Further, as the switch waiting time is hardly influenced by the ratio of data path clock and dot clock, it is possible to prevent from compressing the horizontal blanking period even when the ratio is decreased.

### Second Embodiment

A second embodiment of the present invention is described hereinafter in detail. Note that this embodiment is also a receiving system of television picture and as with the receiving system 100 of FIG. 1, the receiving system of this embodiment includes a receiving unit, display processing unit and display unit. Incidentally, except that a display processing unit is different from the display processing unit 180 of the receiving system 100, other components are same as corresponding components of the receiving system 100. Further, for the display processing unit, except that frame processing units included therein are different from the frame processing units 160 included in the display processing unit 180, other components are same as corresponding components of the display processing unit 180. Thus for the second embodiment, only the frame processing units are described and explanation and drawing for other components are omitted here.

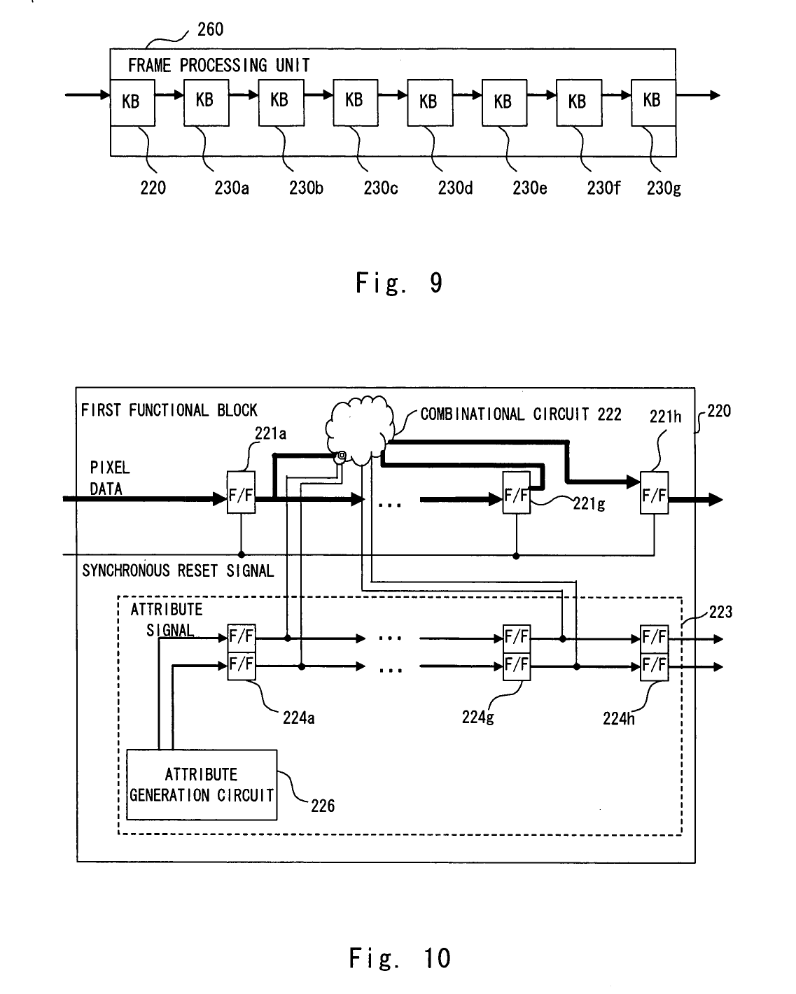

FIG. 9 shows the configuration of a frame processing unit 260 according to the second embodiment. The frame processing unit 260 includes a plurality (8 in this example) functional blocks. To distinguish the first functional block from other functional blocks, the first functional block is given the code 220 and other functional blocks are given the codes 230a to 230g.

FIG. 10 shows the configuration of the first functional block 220. The first functional block 220 includes a plurality of flip-flops, which is 8 in this example, F/Fs 221a to 221h and a combinational circuit 222. The last flip-flop F/F221h passes the pixel data processed by the combinational circuit 222 to the next functional block. Pixel data of one line is input to the first functional block 220 by each pixel, sequentially stored to the F/Fs 221a to 221g and processed in series.

The first functional block 220 further includes a controlling unit 223. The controlling unit 223 includes an attribute signal generation circuit 226 and 8 pairs of flip-flops (F/Fs 224a to 224h pairs for attribute signal) used to transfer an attribute signal.

The attribute signal generation circuit 226 generates a signal indicating whether pixel data is first pixel data and a signal indicating whether the pixel data is last pixel data in one line as an attribute signal. To be more specific, the attribute signal generation circuit 226 activates a signal indicating first pixel data at the same time the first pixel data of one line is input to the first block 220. Further, at the same time the last pixel data of one line is input to the first block 220, the attribute signal generation circuit 226 activates a signal indicating last pixel data. Note that as for a generation of a signal indicating whether or not to be the first pixel data, when inputting number one pixel data after switching a line, this pixel data is made to be the first pixel data. As for a generation of a signal indicating whether or not to be the last pixel data, it may be done in the same way as the attribute signal generation circuit 126 in the receiving system 100 shown in FIG. 5A.

Specifically in this embodiment, a pair of attribute signals is created for each pixel data. The pair of attribute signals synchronized with corresponding pixel data by a flip-flop pair for each attribute signal and transferred. Each combinational circuit 222a to 222g refers to the pair of attribute signals when processing pixel data to perform a process according to whether or not the pixel data is first pixel data or the last pixel data. For example, if the functional block 220 is a horizontal filter, a process to prevent from mixing pixel data of previous line can be performed, such that when processing the first pixel data, only the first pixel data and pixel data input after the first pixel data is used or the first pixel data is output as it is. Further, for the last pixel data, a process to prevent from mixing pixel data of next line can be performed, such that only this pixel data and previously input pixel data is used or output as it is.

When the process result of the pixel data is stored to the last stage F/F221h, a pair of attribute signals thereof is also stored to the F/F pair 224h for attribute signal. Further, when the process result for the F/F221h pixel data is output to the next functional block, the pair of attribute signals stored to the F/F pair 224h for attribute signal is also output to the next functional block.

The functional blocks 230a to 230g other than the first functional block 220 are described hereinafter.

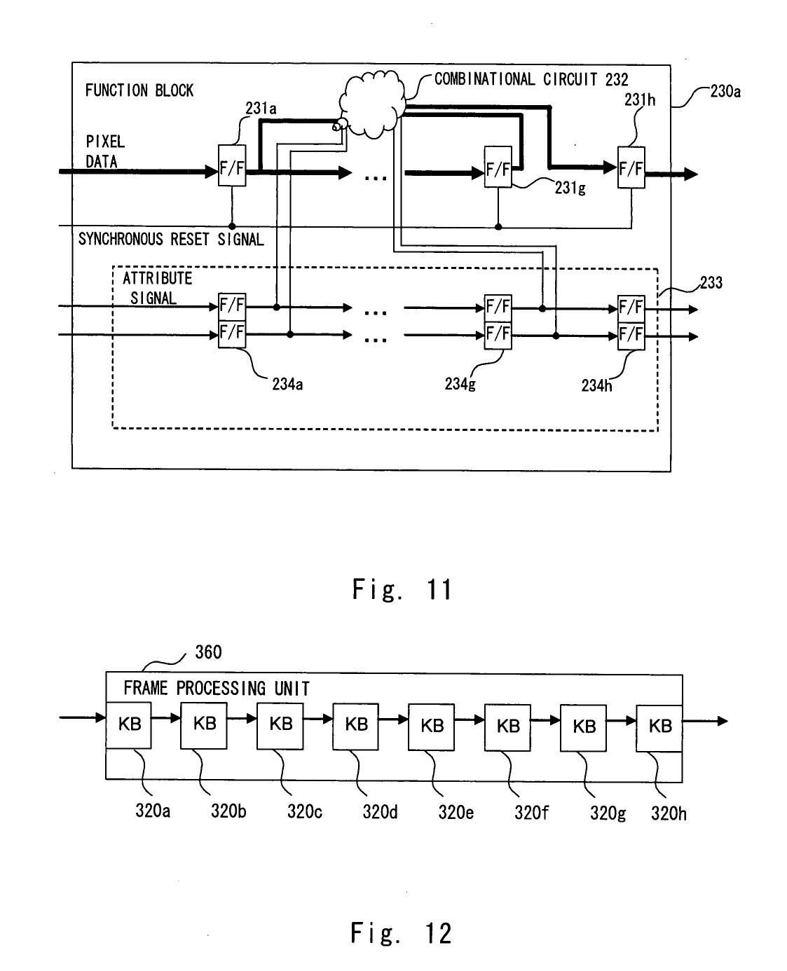

FIG. 11 shows the configuration of the functional block 230a. The functional block 230a includes a plurality of flip-flops (8 in this example) F/Fs 231a to 231h and a combinational circuit 232. The last flip-flop F/F231h passes the pixel data processed by the combinational circuit 232 to the next functional block. Pixel data (result processed by the previous functional block) of one line is input to the functional block 230a by each pixel, sequentially stored to the F/Fs 231a to 231g and processed in series.

The functional block 230a further includes a reset controlling unit 233. The controlling unit 233 includes 8 pairs of flip-flops (F/Fs 234a to 234h pairs for attribute signal) used to transfer a pair of attribute signals that are synchronized with pixel data and output.

Specifically, the controlling unit 223 in the first functional block 220 includes the attribute signal generation circuit 226 so as to control processes of each combinational circuit 232 in the first functional block 220 using the pair of attribute signals generated by the attribute signal generation circuit 226. On the other hand, the control unit 223 in the functional block 230a controls processes of each combinational circuit 232 in the functional block 230a using the pair of attribute signals synchronized with corresponding pixel data and output.

Although the functional block 230a is described here, as the functional blocks 230b to 230g have same configuration as the functional block 120a, detailed explanation for the functional blocks 230b to 230g will be omitted here.

As described above, the pair of attribute signals is generated by the attribute signal generation circuit 226 provided to the first functional block 220, synchronized with the corresponding pixel data and transferred from the previous functional block to the next functional block. The combinational circuits 232a to 232g of each functional block refers to the pair of attribute signals so as to process depending on whether or not the pixel data is the first pixel data or the last pixel data.

In the receiving system 100 of the first embodiment shown in FIG. 1, to start processing pixel data of next line, it achieves to prevent from mixing pixel data of previous line by resetting the memory devices in the functional blocks. On the other hand, in the second embodiment, a pair of attribute signals indicating whether or not it is first pixel data or last pixel data is generated to attach to the pixel data. By doing this, the functional block for performing a process in a horizontal direction as with the horizontal filter refers to the pair of attribute signals to perform a process not to mix the pixel data of the previous line if it is the first pixel data. If it is the last pixel data, the functional block performs not to mix the pixel data of the next line. Specifically, continuous processes can be performed without resetting memory devices at a line switch, thereby eliminating the line switch waiting time.

### Third Embodiment

A third embodiment of the present invention is described hereinafter in detail. Note that this embodiment is also a receiving system of television picture and as with the receiving system 100 of FIG. 1, the receiving system of this embodiment includes a receiving unit, display processing unit and display unit. Incidentally, except that a display processing unit is different from the display processing unit 180 of the receiving system 100, other components are same as corresponding components of the receiving system 100. Further, for the display processing unit, except that frame processing units included therein are different from the frame processing units 160 included in the display processing unit 180, other components are same as corresponding components of the display processing unit 180. Thus for the third embodiment, only the frame processing units are described and explanation and drawing for other components are omitted here.

FIG. 12 shows the configuration of a frame processing unit 360 according to the third embodiment. The frame processing unit 360 includes a scanning unit (not shown) and a plurality (8 in this example) functional blocks 320a to 320h. Incidentally, each functional blocks in the frame processing unit 360 have same configuration, thus the functional block 320a is described as an example and detailed explanation for the other functional blocks 320b to 320h are omitted.

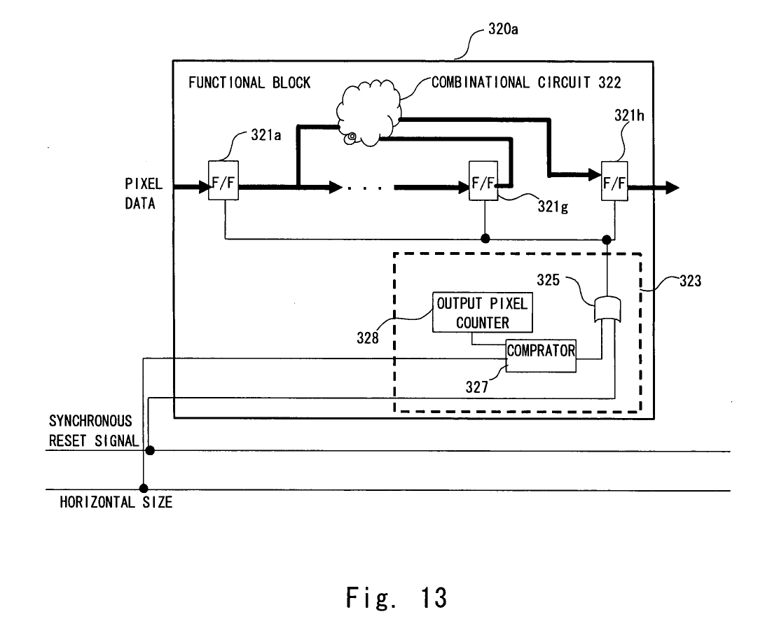

FIG. 13 shows the configuration of the functional block 320a. The first functional block 320a includes a plurality of flip-flops, which is 8 in this example, F/Fs 321a to 321h and a combinational circuit 322. The last flip-flop F/F321h passes the pixel data processed by the combinational circuit 322 to the next functional block. Pixel data of one line is input to the first functional block 320a by each pixel, sequentially stored to the F/Fs 321a to 321g and processed in series.

The functional block 320a further includes a controlling unit 323. The reset controlling unit 323 includes an output pixel counter 328, comparator 327 and reset signal outputter 325.

The output pixel counter 328 counts the number of pixels output from the functional block 320a from when first pixel data of one line is processed and output from the functional block 320a. The comparator 327 compares a horizontal size input to the frame processing unit 360 along with the first pixel data by the scanning unit not shown with the number of pixels counted by the input pixel counter 328 and output the comparison result to the reset signal outputter 325. The reset signal outputter 325 outputs a reset signal when the comparison result shows that the number of pixels counted by the output pixel counter 328 reaches the horizontal size. This resets the F/Fs 321a to 321h in the functional block 320a. Specifically, when last pixel data of one line is processed and output, the F/Fs 321a to 321h in the functional block 320a are reset.

Note that the reset signal outputter 125 outputs a reset signal when receiving a synchronous reset signal so as to reset the F/Fs 321a to 321h in the functional block 320a besides when the last pixel data is processed and output.

As described in the foregoing, in the third embodiment, if the pixel data processed by each functional block in the frame processing unit 360 is the last pixel data, the functional block synchronizes with a timing to output the process result so as to reset its own memory device. By doing this, same advantageous effects can be achieved as with the first embodiment shown in FIG. 1.

Having thus described the present invention by reference to certain of its preferred embodiments, it is noted that the embodiments disclosed are illustrative and that a wide range of variations, modifications, changes, and substitutions are contemplated in the foregoing disclosure. Many such variations and modifications may be considered desirable by those skilled in the art based upon a review of the foregoing description of preferred embodiments.

It is apparent that the present invention is not limited to the above embodiments, but may be modified and changed without departing from the scope and spirit of the invention.

What is claimed is:

1. An image processing circuit to sequentially process each pixel data constituting one line, the image processing circuit comprising:
a plurality of memory devices each holding the pixel data being sequentially input;
a processing unit to process pixel data held by a predetermined memory device among the plurality of memory devices; and
a reset controlling unit to reset the plurality of memory devices in synchronization with a timing of last pixel data of the one line being processed and output by the processing unit.

2. The image processing circuit according to claim 1, wherein the processing unit performs a process using each pixel data held in the plurality of continuous memory devices.

3. The image processing circuit according to claim 2, wherein at first pixel data of one line being held to a predetermined memory device among the plurality of continuous memory devices, pixel data processed using the first pixel data is stored from the predetermined memory device to the memory device in a direction of process.

4. The image processing circuit according to claim 2, wherein the processing unit holds pixel data in a memory device of a next stage and repeats this process sequentially, the pixel data being the processed pixel data held in the memory device.

5. The image processing circuit according to claim 2, wherein the processing unit is controlled by a signal synchronized with a timing first or last pixel data of the one line sequentially transfers the memory device.

6. The image processing circuit according to claim 1, wherein the reset controlling unit refers to an attribute signal to control resetting the memory device, the attribute signal being generated when last pixel data is input to the processing unit and transferred in synchronization with a timing the pixel data is transferred to the memory device.

7. The image processing circuit according to claim 6, wherein the reset controlling unit comprises:
an input pixel counter to count the number of pixel data being input with a start point as first pixel data of one line; and
a comparator to compare the counted number by the counter with a total number of pixel data in the one line,
wherein for pixel data being input at an indication by the comparison result of the comparator showing a match, an attribute signal is generated indicating the pixel data is last pixel data.

8. An image processing system comprising:
a plurality of the image processing circuits of claim 1 being connected in order for a lower image processing circuit to sequentially processes pixel data output from an adjacent upper image processing circuit.

9. The image processing system according to claim 8, wherein to each pixel data being input, the reset controlling unit in a top image processing circuit generates and attaches an attribute signal indicating whether or not the pixel data is last pixel data and at an output of the processed pixel data, the reset controlling unit refers to the attribute signal of the pixel data so as to control the reset, and
the reset controlling unit in other image processing circuit refers to the attribute signal attached to the pixel data at an output of pixel data by the image processing circuit so as to control the reset.

10. The image processing circuit according to claim 9, wherein the reset controlling unit in the top image processing circuit comprises:
an input pixel counter to count the number of pixel data being input with a start point as first pixel data of one line; and
a comparator to compare the counted number by the input pixel counter with a total number of pixel data in the one line,
wherein for pixel data being input at an indication of the comparison result of the comparator shows the both numbers match, an attribute signal is generated indicating the pixel data is last pixel data.

11. The image processing circuit according to claim 1, wherein the reset controlling unit comprises:
an output pixel counter to count the number of pixel data being processed and output with a start point as first pixel data of one line; and
a comparator to compare the counted number by the output pixel counter with a total number of pixel data in the one line,
wherein the reset is performed at an indication the comparison result of the comparator shows a match.

12. An image processing system comprising:
a plurality of the image processing circuits according to claim 11 being connected in order for a lower image processing circuit to sequentially processes pixel data output from an adjacent upper image processing circuit.

13. An image processing circuit to sequentially process each pixel data constituting one line, the image processing circuit comprising:
a controlling unit to generate and attaches an attribute signal to each of the pixel data being input, the attribute signal indicating whether or not the pixel data is first pixel data or last pixel data.

14. An image processing system comprising:
a plurality of image processing circuits being connected to sequentially process each pixel data constituting one line in order for a lower image processing circuit to sequentially process pixel data output from an adjacent upper image processing circuit,
wherein a top image processing circuit is the image processing circuit of claim 13.

15. A method to process image to sequentially process each pixel data constituting one line, the method comprising:
holding the pixel data sequentially input in a plurality of memory devices in order of input;
processing and outputting pixel data held in a predetermined memory device among the plurality of memory devices; and
resetting the plurality of memory devices in synchronization with a timing last pixel data of the one line is processed and output.

16. The method according to claim 15, further comprising:
performing a process using each pixel data held in the plurality of continuous memory devices.

17. The method according to claim 15, further comprising:
generating and attaching to each pixel data being input, an attribute signal indicating the pixel data is last pixel data; and
performing the reset at an indication of the attribute signal for pixel data showing to be last pixel data in outputting the processed pixel data.

18. The method according to claim 17, further comprising:
counting the number of pixel data being input with a start point as first pixel data of one line;
comparing the counted number with a total number of pixel data in the one line; and
generating an attribute signal indicating pixel data to be last pixel data for the pixel data being input at an indication of the comparison result showing a match.

19. The method according to claim 15, which is processed in each processing circuit of an image processing system including a plurality of the image processing circuit being connected to sequentially process each pixel data constituting one line in order for a lower image processing circuit to sequentially process pixel data output from an adjacent upper image processing circuit.

20. The method according to claim 19, further comprising:
performing a process using each pixel data held in the plurality of continuous memory devices.

21. The method according to claim 19, wherein in a top image processing circuit, for each pixel data being input, an attribute signal indicating whether or not the pixel data is last pixel data is generated and attached and in outputting processed pixel data, the reset is performed at an indication of the attribute signal for the pixel data being the last pixel data, and
in other image processing circuit, in outputting pixel data processed by the image processing circuit, the reset is performed at an indication of the attribute signal for the pixel data being the last pixel data.

22. The method according to claim 15, further comprising:
counting the number of pixel data being input with a start point as first pixel data of one line; and
comparing the counted number with a total number of pixel data in the one line,
wherein the reset is performed at an indication of the comparison result showing a match.

23. The method according to claim 19, further comprising:
counting the number of pixel data being input with a start point as first pixel data of one line; and
comparing the counted number with a total number of pixel data in the one line,
wherein the reset is performed at an indication of the comparison result showing a match.

24. A method to process image to sequentially process each pixel data constituting one line, the method comprising:
generating and attaching an attribute signal to each of the pixel data being input, the attribute signal indicating whether or not the pixel data is first pixel data or last pixel data.

25. A method to process image in an image processing system including a plurality of image processing circuits being connected to sequentially process each pixel data constituting one line in order for a lower image processing circuit to sequentially process pixel data output from an adjacent upper image processing circuit, the method comprising:
generating and attaching in a top image processing circuit an attribute signal to each of the pixel data being input, the attribute signal indicating whether or not the pixel data is first pixel data or last pixel data.
